(19) United States
(12) Patent Application Publication
(10) Pub. No.: US 2007/0034634 A1
(43) Pub. Date: Feb. 15, 2007

(54) Hydration system with articulating port structure

(76) Inventor: Dennis B. Brown, Logan, UT (US)

Correspondence Address: HOLME ROBERTS & OWEN, LLP, 299 SOUTH MAIN, SUITE 1800, SALT LAKE CITY, UT, 84111, US

(21) Appl. No.: 11/200,318

(22) Filed: Aug. 9, 2005

(51) Int. Cl. A47G 19/22; A45F 3/16; B67D 3/00

(52) U.S. Cl. 220/703; 222/529; 224/148.2

(57) ABSTRACT

A hydration system is described, including a pouch for storing fluid, a flexible conduit connected to the pouch for delivering fluid to the user, and a rotatable port structure connected to both the conduit and the pouch, the port structure having at least two components connected in a moveable joint structure about a first axis of rotation—a surface mount receiver mounted to the surface of the pouch and an outlet connector that is rotatably connected to the surface mount receiver in a watertight arrangement. A quick connect apparatus may also be attached to the outlet connector for quickly connecting and disconnecting the conduit from the port structure and providing a second axis of rotation.

### BACKGROUND OF THE INVENTION

1. The Field of the Invention

This invention relates to hydration systems and more particularly to portable hydration systems having a supply tube for communicating fluid from a reservoir to a user.

2. The Relevant Technology

Portable hydration systems have evolved to include arrangements much like a back pack that include a flexible pouch to retain and transport hydration fluids (e.g., water). The flexible pouch has an inlet for the user to supply desired fluids and an outlet to which a supply tube is connected. The supply tube or conduit has a mouthpiece at the other end that includes a valve operable by a user to access the fluid as desired. Typically, a bite valve or other fluid transfer mechanism is positioned at the end of the supply tube operable by user between a closed position and an open position. In the open position, the user may draw the hydration fluid out of the flexible pouch.

The tube or conduit is typically of a length that extends from the bottom of the pouch on the user's back over the user's shoulder or under the user's arm to the vicinity of the user's mouth. The tube typically is connected to the pouch in the vicinity of a seam where the side walls of the pouch are joined. In other systems, the tube is connected to the pouch at a location on one of the side walls.

In some systems, the tube is attached to the pouch with a rigid portal or connecting member that either extends directly out from the side wall, or that has an elbow configuration. When the connecting member has an elbow configuration, it ordinarily directs the tube up the user's back towards the shoulder or to the side of the user's back. Such an arrangement does not work well for medical hydration applications, where the hydration pack is used for wheelchair or bedridden individuals, or certain outdoor activities, such as a shower application, where the configuration of the elbow configuration should be downward instead of upward.

When the connecting member is attached to the side wall, the connecting member and the end of the tube close to the pouch are typically in a fixed position, and cannot be rotated or pivoted around the point where the tube is attached to the pouch. This arrangement poses a significant problem when the pouch is removed for filling or cleaning. Further, when the tube's position is adjusted by the user, the portion of the tube adjacent the fixed connecting member is subject to twisting and bending, which can constrict the tube and hinder flow of fluid through the tube.

### BRIEF SUMMARY OF THE INVENTION

A hydration system includes a pouch for storing fluid, a flexible conduit for delivering fluid from the pouch to the user, a surface mount receiver located in a side wall of the pouch through which fluid can pass, an outlet connector that is connected to the surface mount receiver and to a proximal end of the conduit, and a quick connect for easily connecting and disconnecting the conduit from the pouch. The outlet connector is configured to rotate relative to the portal structure. The surface mount receiver is attached to a side wall in the bottom portion of the pouch, proximate an opening in the side wall so that fluid passes from the pouch and into the portal structure.

The port structure is generally articulated, and includes at least two sections connected at a joint so that one section can move relative to the other. The first section includes the male coupling element of an outlet connector that provides attachment to the surface mount receiver. The second section is a female coupling element in a surface mount receiver that receives the male coupling element of the outlet connector. The movement of the two sections relative to each other may be rotational, with the first section rotating around a longitudinal axis of the second section. The conduit is connected to the outlet connector. The outlet connector may include a valve for controlling the flow of fluid through the outlet connector.

The quick connect apparatus rotates relative to an axis of rotation extending through the approximate centers of the opening of the conduit, the inlet and male coupling element of a male insert adapter, the female coupling of the quick connect and the inlet to the outlet connector. The outlet connector rotates relative to the surface mount receiver around an axis of rotation extending through the approximate centers of each. This arrangement provides a dual axis of rotation, one at the connection between the female coupling of the quick connect apparatus and the male coupling of the male insert adapter and a second at the moveable joint structure coupling the outlet connector to the surface mount receiver.

In one embodiment, the surface mount receiver comprises a plurality of ridges on the bottom of the surface mount receiver for providing a fluid pathway when in operation. When under suction, the ridges prevent the bottom of the surface mount receiver from directly contacting a bladder wall and essentially forming a watertight seal thus blocking the opening thereby sealing off the flow of fluid from the opening to the bladder.

In another embodiment, the conduit may be disconnected from the quick connect element. This arrangement allows for the provision of one of a plurality of connectable elements to be connected to the female coupling of the quick connect at the port structure. Connectible elements include any structure that may be connectable to a hydration system, such as a shower element, a water filtration system, medical hydration system, a mobile water tank and a replacement mouthpiece structure to name a few. The connectable element is fitted with a corresponding male coupling element that is sized and configured to mate with the female coupling element of the quick connect to provide a watertight seal and therefore reduce if not eliminate the loss of fluid from the bladder.

In yet another embodiment, the quick connect element is provided with an internal valve configuration. The internal valve configuration restricts the flow of fluid through the quick connect when the quick connect is detached from a connectable element. This arrangement substantially reduces the loss of fluid from the bladder and out of the conduit when, for example, the male coupling of the male insert adapter coupled to a conduit is disconnected from the female coupling of the quick connect and, a period of time later, the male coupling of a shower device is connected to the female coupling of the quick connect to provide a shower apparatus for a hiker.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one example of a hydration system;

FIG. 2 shows the hydration system of FIG. 1 in use;

FIG. 3 illustrates a front perspective view of one embodiment of a port structure;

FIG. 4 illustrates an exploded front perspective view of another embodiment of a port structure having a quick connect or quick disconnect for connecting and disconnecting a conduit to and from the outlet connector;

FIGS. 5-8 depict a top perspective view, a bottom perspective view, a top view and a cut-away view of the surface mount;

FIGS. 9-12 show a top perspective view, a side view, a front view and a cut-away view of one embodiment of an outlet connector;

FIGS. 13-16 illustrate a top perspective view, a side view, a front view and a cut-away view of another embodiment of an outlet connector;

FIGS. 17-20 depict a top perspective view, a side view, a front view and a cut-away view of a male insert;

FIGS. 21-22 show one embodiment of the components that provide the rotational movement and watertight seal for the combination of an outlet connector and a surface mount receiver;

FIG. 23 illustrates one embodiment of a connectable element in the form of a mouthpiece.

### DESCRIPTION OF A PREFERRED EMBODIMENT

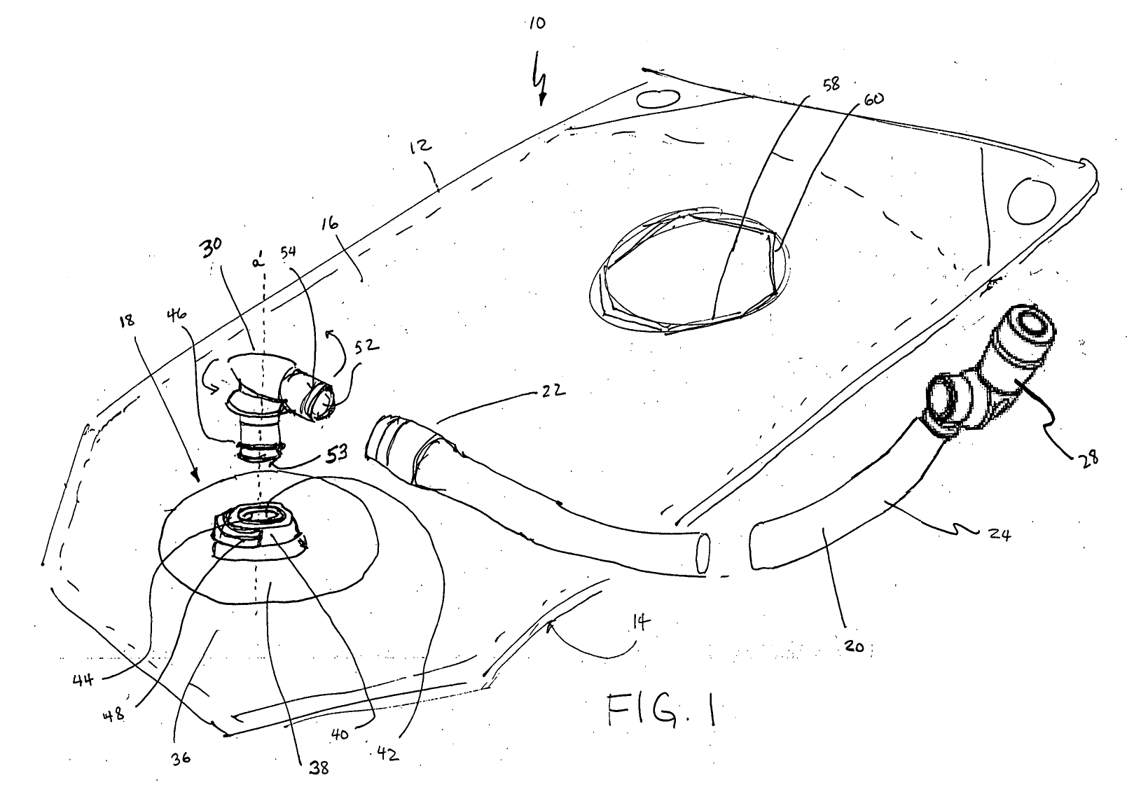

The present invention relates to portable hydration systems for storing fluid and delivering fluid to a user. FIG. 1 illustrates one embodiment of a hydration system 10. Hydration system 10 comprises a pouch or bladder 12 for storing fluid. The bladder 12 generally comprises at least two side walls—an inner side wall 14 and an outer side wall 16—and a surface mount receiver or portal structure 18 attached to the outer side wall 16. A flexible tube or conduit 20 is coupled to surface mount receiver 18. Flexible tube 20 has a proximal end 22 that is coupled to surface mount receiver 18 for receiving fluid from bladder 12 and a distal end 24 for delivering the fluid from the pouch 12 to the user. In the illustrated example, a mouthpiece or bite valve 26 is connected to the distal end 24 of the tube 20 proximate the user to facilitate delivery of the fluid from the pouch 12 to a user.

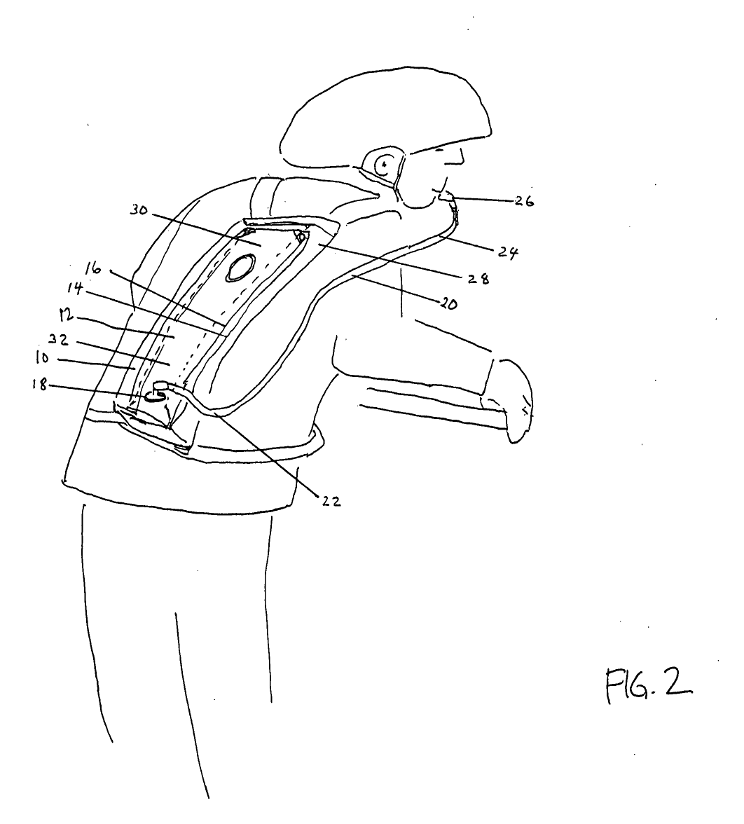

The tube or conduit 20 is typically a hollow conduit for passing fluid from the pouch 12 to the user. The conduit 20 may be formed of any number of flexible plastic materials in any number of sizes that is currently used for a typical hydration system. In a preferred embodiment, conduit 20 is a flexible medical grade poly tubing having an outside diameter of about 0.5 inches. The bite valve 26 is secured or attached to the distal end 24. As shown in FIG. 2, the conduit 20 is sized in length so that it will reach from a typical user's lower back to the user's mouth. In addition, the conduit 20 is formed and located such that the user can effortlessly position conduit 20 in the user's mouth when in use, or easily store conduit 20 in the back-pack structure while traveling.

A surface mount receiver 18 is positioned on the lower portion 36 of the outer side wall 16, proximate an opening (not shown) in the side wall so that fluid passes from the pouch 12 into the surface mount receiver 18. The surface mount receiver 18 permits both the discharge of fluid from the pouch 12 and the introduction of fluid to the pouch 12. The plate 38 has an aperture (not shown), positioned proximate the opening in the side wall 16.

In the illustrated embodiment, the surface mount receiver 18 includes a plate 38 that attaches and seals to the outer side wall 16 around the opening in such side wall 16. For example, plate 38 may be sealed within the layers of a multi-layered or dual-layered side wall. However, it should be readily apparent to one skilled in the art that there are numerous methods for attaching the plate 38 to the side wall 16, and there is no intent to limit the present description to any particular method of attachment.

The surface mount receiver 18 includes a surface mount 40, attached or integrally molded to the surface of the plate 38 at a location opposite the side wall 16. The surface mount 40 is a raised structure with a central conduit 42 for passing fluid. Attached to the interior of the central conduit 42 is a female coupling element 44, that may be a raised rubber lip, rubber ring or gasket, adapted and suitably sized to form a watertight seal when coupled to portal connector or outlet connector 30. The outlet connector 30 includes a male coupling element 46, illustrated as a plurality of raised rubber rings or gaskets, adapted to create a seal with the central conduit 42 of the surface mount 40. The illustrated embodiment using a female coupling element and a male coupling element shows one of many configurations for providing a pivotal watertight seal between the pivotal connector 30 and the surface mount receiver 18. Therefore, the sealing method is not limited solely to the illustrated method.

The outlet connector 30 and the surface mount receiver 18 are preferably formed of lightweight plastic material, although other materials, such as metals, may be used.

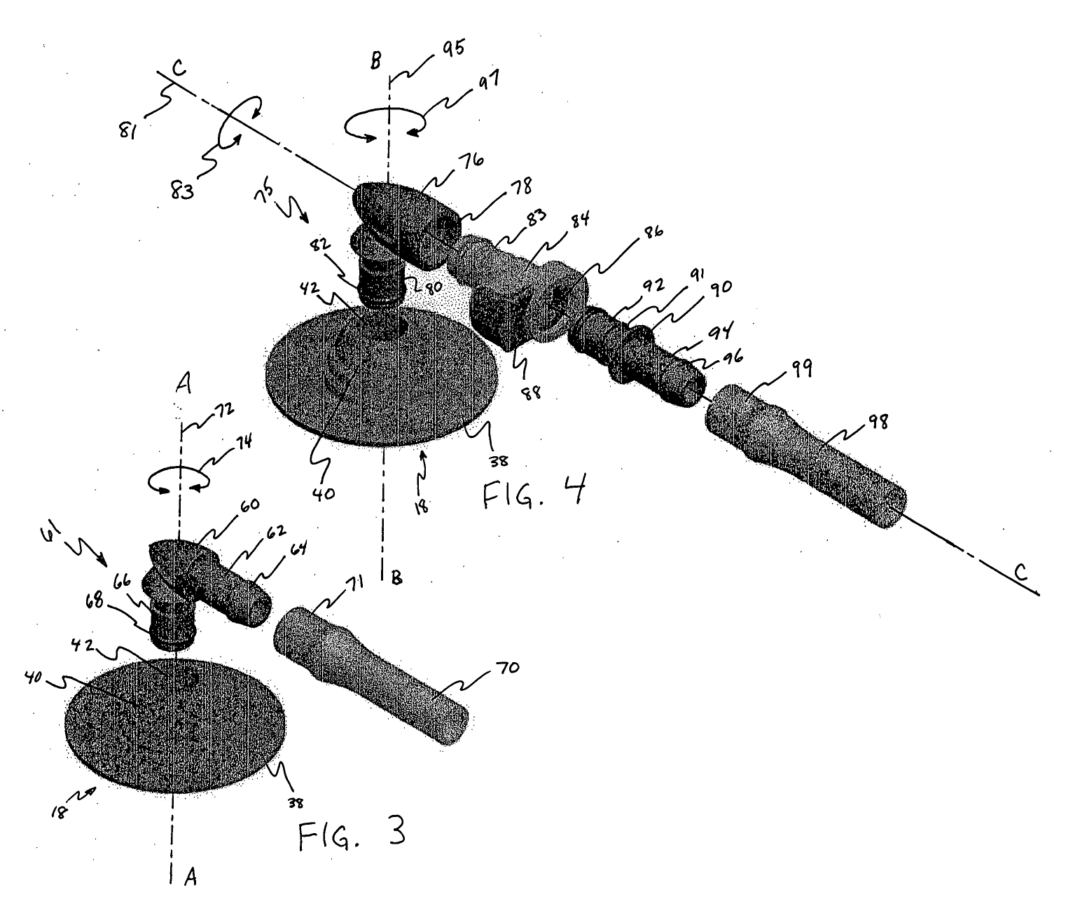

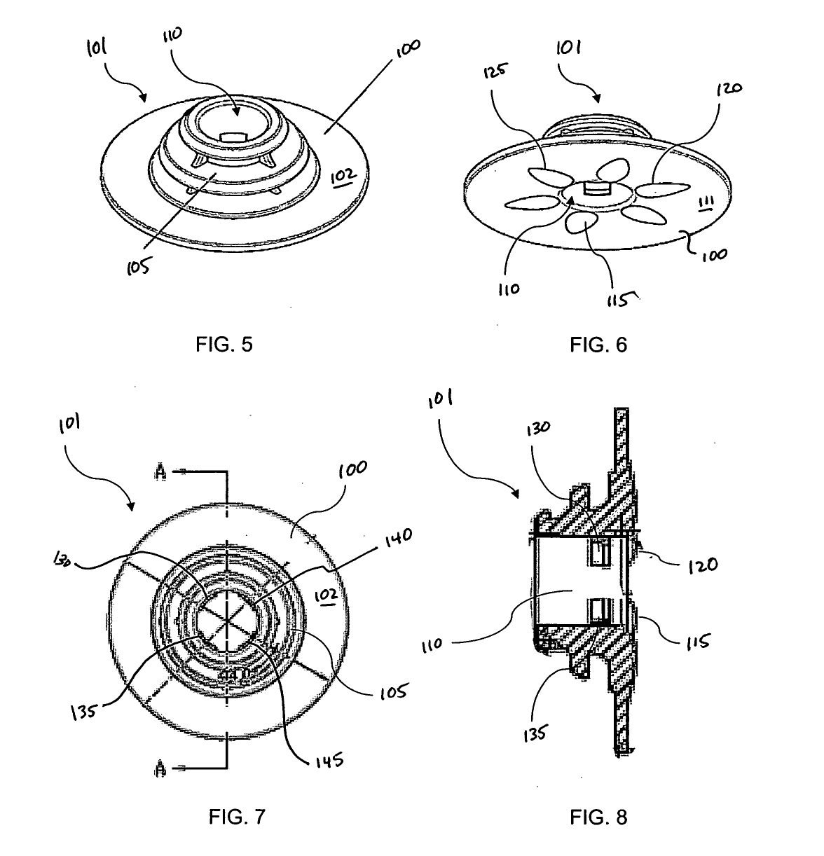

In addition to being sold as part of a complete hydration system 10, the outlet connector 30 and conduit 20 combination can be sold and used as replacement parts. Additionally, the outlet connector 30, tube 20, and surface mount receiver 18 may be sold individually or together (such as the configurations shown in FIGS. 3 and 4), and used as replacement parts for hydration systems having the articulating port system of the present invention, or for retrofitting existing systems that do not have the present articulating port system.

The pouch 12 includes a second portal structure 58 with a cap 60 in the outer side wall 16 or a seam of its top portion, through which fluid can pass. The preferred use of the second portal structure 58 is for introduction of fluid to re-supply the pouch 12, although it can be used for other purposes such as the discharge of fluid from the pouch and cleaning the interior of the pouch.

In operation, the male end 53 of the outlet connector 30 is inserted into the central conduit 42 of the surface mount 40. Upon integration, the female coupling element 44 engages male coupling element 46, thereby providing a watertight connection for fluid to flow from the pouch 12 into the outlet connector 30, and eventually to a connectable element.

It should be appreciated that, in operation, the user may adjust the position of the flexible conduit 20. When the conduit 20 is adjusted, the outlet connector 30 is capable of articulating and moving in response to the adjustment. Further, the plate 38 and surface mount 40 of the surface mount receiver 18 provide support and stability and protect the side wall 16 from tearing when the outlet connector 30 articulates in response to the position of conduit 20.

FIG. 2 illustrates the use of hydration system 10 by a user. While the user is illustrated as a human, it is within contemplation that the hydration system 10 could be attached to different animals who may be trained to operate a bite valve which may be reconfigured for use by an animal. In the illustrated embodiment, the pouch 12 of hydration system 10 can be housed in a back pack structure 28 that is typically worn on a user's back. In general, the pouch 12 has an oblong shape, and is positioned in the back pack structure 28. A top portion 30 of the pouch 12 is proximate the user's upper back and a bottom portion 32 is proximate the user's lower back. In the illustrated embodiment, the inner side wall 14 of pouch 12 is positioned adjacent a user's back and outer side wall 16 opposes the inner side wall 14 and faces in a direction generally away from the user's back.

While the hydration system 10 here discussed includes or is in the form of a pack, which is typically referred to as a back pack, it may be in a wide variety of forms, such as a hip type or lumbar type hydration pack. Any hydration system or apparatus will be suitable so long as it has a means for delivering fluid from a conduit to a user, as discussed hereinafter, and a container means to retain the fluid that is dispensed through the conduit for consumption.

FIG. 3 illustrates one embodiment of an articulating port structure 61 having a snap fit connection between the outlet connector 60 and the surface mount 40 of surface mount receiver 18. Outlet connector 60 has an outlet 62 with a barbed or ridged element 64 for connecting outlet connector 60 to a conduit 70. In operation, the connection between the outlet 62 and the proximal end 71 of conduit 70 is typically a friction fit created by pushing the proximal end 71 of the tube 70 over a barbed element 64 of the outlet 62, thereby effectuating a water tight seal between conduit 70 and outlet 62 of outlet connector 60.

The male end 66 of outlet connector 60 has a male coupling element or O-ring 68 for forming a watertight seal with a female coupling element located within central conduit 42 of surface mount 40. In operation, the connection between outlet connector 60 and surface mount 40 is created by snap fitting male end 66 into central conduit 42, thereby creating a watertight seal between the female coupling element (not shown) of surface mount 40 and the male coupling element 68 of the outlet connector 60.

In operation, the male end 66 and male coupling element 68 are inserted into the central conduit 42, thereby connecting male coupling element 68 to the female coupling element (not shown) of surface mount 40 of surface mount receiver 18. The combination forms a moveable joint structure, thereby rotatably connecting the outlet connector 60 to the surface mount 38. The joint structure is configured so that the male end 66 can rotate within the central conduit 42, thereby also causing the position of the outlet connector 60 to change relative to the position of the surface mount receiver 18.

The outlet connector 60 is adapted to rotate in a direction 74 relative to an axis of rotation A, as shown in FIG. 3. As such, axis A defines the axis of rotation 72 by which outlet connector 60 rotates relative to surface mount 40 of surface mount receiver 18. In the illustrated embodiment, the movement of the outlet connector 60 is rotational in nature, although the joint structure may be configured to permit other forms of movement, in which the outlet connector 60 moves in a pivoting or swiveling movement relative to the surface mount 38.

FIG. 4 illustrates another embodiment of an articulating port structure 75 having a quick connect 84 for easily connecting and disconnecting conduit 98 to and from outlet connector 76. The pivotal structure and operation of the male end 80 and male coupling element 82 and surface mount receiver 18 of port structure 75 functions in a similar manner to that described with respect to port structure 61. As such, the outlet connector 76 is adapted to rotate in a direction 97 relative to an axis of rotation B 95, as shown in FIG. 4. The addition of the quick connect 84 provides an alternate means for connecting and disconnecting the conduit 98 to and from the port structure 75.

The body portion 83 of quick connect 84 is press fit into the female portion 78 of outlet connector 76. In the illustrated embodiment, the quick connect 84 is a spring loaded connector with a button 88 for releasing the spring loaded locking mechanism (not shown). In a preferred embodiment, the quick connector or quick disconnect is manufactured by Colder Products, Inc. Significantly, quick connect apparatus 84 has an internal valve (not shown) that is configured to prevent the flow of fluid through the quick connect apparatus 84 when a male coupling element is disconnected from the female coupling element 86. This internal valve provides a means for connecting and disconnecting the conduit 98 from the port structure 75 so that the internal valve seals the internal chamber of the quick connect apparatus 84, thereby preventing precious fluid loss from the bladder.

Male insert connector 90 generally comprises an inlet 92 and a male coupling element 94. The male coupling element 92 is sized and configured to connect to the female coupling end 86 of quick connect 84. The male coupling element 92 has an O-ring element 91 that, when connected with quick connect apparatus 84, seals against the interior wall of quick connect 84 to create a watertight seal. Male insert connector 90 also includes an outlet 94 that is configured and sized for insertion into the distal end 99 of conduit 98. To create a tight seal, the outlet 94 of male insert connector 90 has a barbed fitting 96 sized to snugly receive the distal end 99 of conduit 98 thereover. Accordingly, the male insert connector 90 may be secured or attached to the distal end 99 of conduit 98.

In operation, the male coupling element 92 of male insert adapter 90 is inserted into the female coupling element 86 of the quick connect 84 until the spring loaded connector engages. The spring loaded mechanism (not shown) internal to quick connect 84 connects with ribbed portion 91 of male coupling element 92, thereby locking the male insert adapter 90 in place, the o-ring 91 creating a watertight seal between quick connect 84 and the male insert adapter 90.

In the illustrated embodiment, the outlet connector 76 and the surface mount receiver 18 are connected by a moveable joint structure that enables the outlet connector 76 to change orientation relative to the surface mount receiver 18. Similarly, the quick connect 84 is constructed to allow the male coupling element 92 of male insert adapter 90 to rotate within the female coupling element 86 of quick connect 84 while maintaining a watertight seal.

The conduit 98 and male insert connector 90 rotate relative to an axis of rotation C 81 extending through the approximate centers of the opening of the quick connect apparatus 84, the male insert adapter 90 conduit 98. As stated previously, the outlet connector 76 rotates relative to the surface mount receiver 18 around an axis of rotation B 95 extending through the approximate centers of the male coupling element 80 and the opening to central conduit 42. This arrangement provides a dual axis of rotation, one at the point of connection between outlet connector 76 and the surface mount receiver 18 and a second at the point of connection between the female coupling 86 of the quick connect 84 and the male coupling 92 of the male insert adapter 90. Advantageously, the dual axis of rotation keeps the conduit from tangling.

In operation, the conduit 98 may be quickly removed from outlet connector 76 by pressing button 88, which releases male insert adapter 90 from quick connect 84. The advantages to such an arrangement are many. Significantly, the ability to remove the conduit from a rotating port structure enables the user to completely remove the bladder from a hydration system without having to worry about removing the conduit from the hydration system as well. The connect/disconnect feature of the quick connect 84 is highly advantageous for filling a bladder with fluid, since the bladder may be easily disconnected from the conduit, filled with fluid and returned to the hydration system. In addition, the ability to remove the conduit 98 from the port structure 75 and rotate the outlet connector 76 relative to surface mount receiver 18 provides a means for adding different add-ons or connectable elements, such as a shower adapter, medical hydration system for a wheelchair bound or bedridden individual, and a water filtration system to name a few.

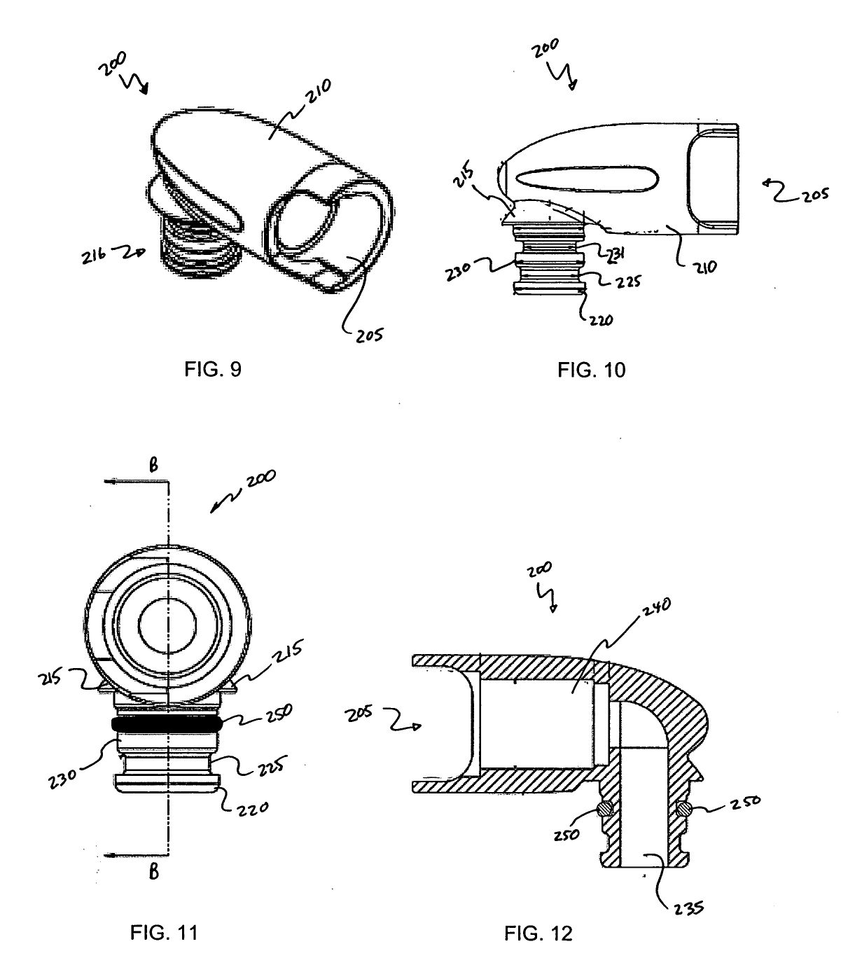

FIGS. 5-20 illustrate various components, including alternative embodiments, of the hydration system of the present invention. More particularly, FIGS. 5-20 show multiple views of embodiments of an outlet connector, a surface mount receiver and a male insert illustrated and described with respect to FIGS. 3 and 4.

FIGS. 5-8 illustrate a top perspective view, bottom perspective view, top view and cut-away view respectively of a snap-in surface mount receiver structure 101 in accordance with the present invention. As shown in FIG. 5, surface mount receiver 101 comprises a female press fit connector 105 on a plate 100 for removably securing a male end of an outlet connector (not shown) to a female connector means within the interior channel 110 of surface mount receiver 101. Press fit connector 105 has an opening leading to an interior channel 110 for receiving the male portion of a outlet connector.

FIG. 6 shows a bottom perspective view of surface mount receiver 101 comprising a plurality of raised ridges 115, 120, 125 on the bottom surface 111 of plate 100. In use, surface mount structure 101 is mounted to a bladder 12 as illustrated in FIG. 1. The top surface 102 of plate 100 is attached to the interior of bladder 12 and forms a watertight seal.

In certain circumstances, such as hydration system is under suction during operation, the bottom 111 of plate 100 is forced towards an interior wall of a bladder that is adjacent to the wall of the bladder 12 that plate 100 is mounted. Ridges 115, 120, 125 facilitate the creation of a fluid path between a wall of the bladder 12 and adjacent ridges. The ridges 115, 120, 125, and not the bottom 111 of plate 100, contact the adjacent bladder wall thereby creating a path for fluid to flow between adjacent ridges. By creating an alternate fluid pathway, ridges 115, 120, 125 prevent the adjacent wall of bladder 12 from closing off the flow of fluid through the inner channel 110 when a hydration system is under suction during operation.

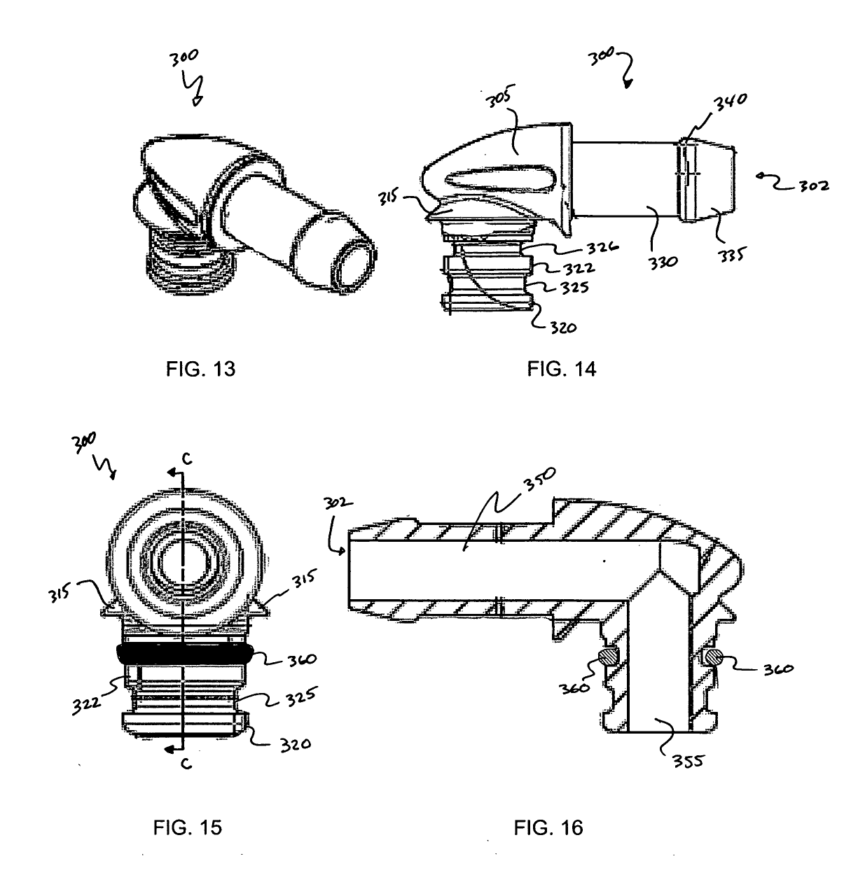

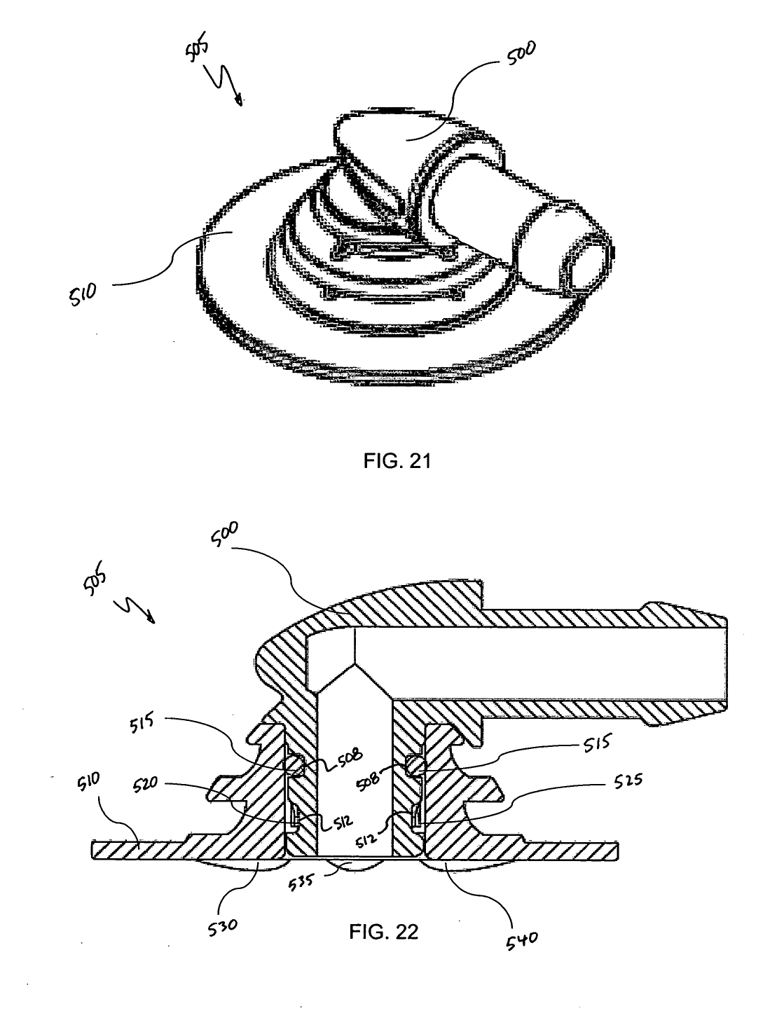

FIG. 7 shows a top view of surface mount receiver 101 and FIG. 8 depicts a side view, cut-away portion A-A of surface mount receiver 101. Surface mount receiver 101 has an interior fluid channel 110 for directing fluid from the interior of a bladder (shown in FIG. 1) to a portal connector or outlet connector (shown in FIGS. 9 and 17). Surface mount 101 also comprises a plurality of female connector means 130, 135 for connecting to a male portion of an outlet connector.

To effect a connection, the male portion of an outlet connector is press fitted into an interior channel 110 of surface mount receiver 101. A section of the male portion of the outlet connector engages the plurality of female connector members 130, 135 located within the interior channel 110 of pressure connector 101. The connection between the male portion of the outlet connector allows the male portion to freely rotate 360° within the interior channel 110 relative to the surface mount receiver 101, but also provides a watertight seal at the point of connection.

FIGS. 9-12 show a top perspective view, a side view, a front view and a cut-away view respectively of one embodiment of an outlet connector or outlet connector 200. As shown in FIG. 9, the outlet connector 200 has a proximal portion 210 having an opening 205 that is configured to snap fit with a male portion of a connecting member (not shown). The outlet connector 200 has a male end 216 with a male coupling means 220, 225, 230, 231, 250 for press fitting to a surface mount receiver 101 shown in FIG.5. The press fitting connection between the male coupling means of an outlet connector 200 and the female receiving portion of a surface mount receiver 101 creates an articulating joint between the outlet connector and the surface mount receiver, while maintaining a watertight seal between the two elements.

FIG. 10 illustrates a male coupling portion 216 comprising a bottom portion 220, a top portion 230 and a locking means 225 there between. Male coupling portion 216 also includes a sealing means 231 adapted to receive o-ring 250 as shown in FIGS. 11 and 12. In operation, the male potion 216 is inserted into the interior chamber 110 of surface mount receiver 101. The bottom portion passes over the plurality of female connector means 130, 135, 140, 145 and the locking means 225 engages the plurality of female connector means 130, 135, 140, 145 between the top portion 230 and the bottom portion 220. The stop 215 contacts the top surface of a connector 105 of surface mount 101, thereby preventing the male coupling end 216 from extending too far within interior channel 110. The connection between the coupling means 225 and the female connector means 130, 135, 140, 145 allows the outlet connector 200 to rotate 360° relative to the surface mount receiver 101.

FIG. 11 shows a front view of outlet connector 200 and FIG. 12 shows a side cut-away section B-B of outlet connector 200. The sealing means 231, when fitted with an o-ring 250, creates a watertight seal between the outlet connector 200 and the interior channel 110 of surface mount receiver 101. Outlet connector has interior fluid channels 235, 240 for directing fluid from the interior of a bladder (shown in FIG. 1) to the opening 205 of portal connector or outlet connector 200. The outlet connector 200 facilitates the flow of fluid from the bladder or pouch, through the surface mount receiver to a conduit and ultimately to a connectable element connected to the distal end of a conduit. The outlet connector 200 may also include a valve structure to control the flow of fluid through the connector.

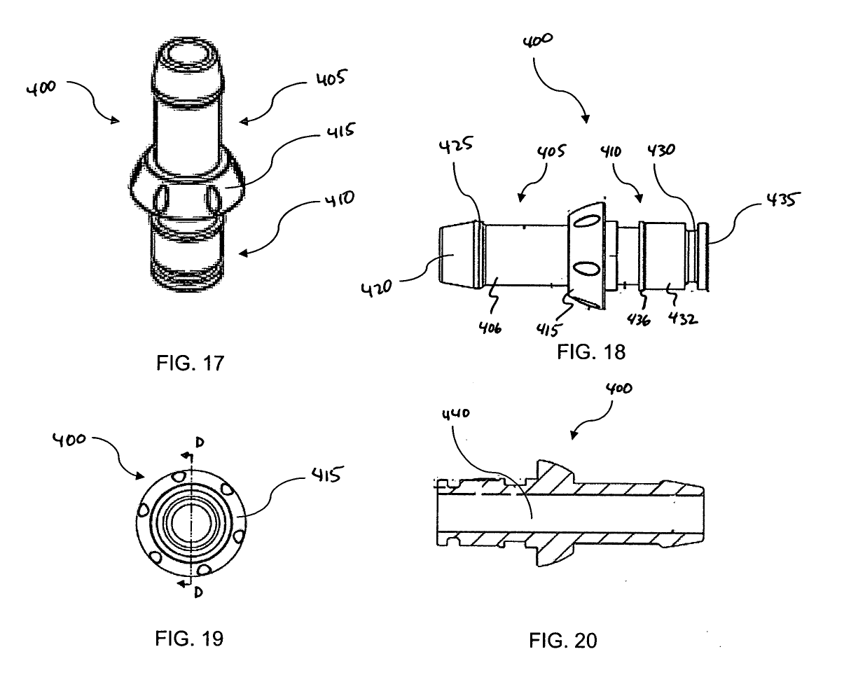

FIGS. 13-16 illustrate a top perspective view, side view, front view and cut-away view respectively of another embodiment of an outlet connector or outlet connector 300. As shown in FIGS. 13 and 14, outlet connector 300 has a male portion 310 with a coupling means 320, 322, 325, and a sealing means 326, 360 for creating an articulating, watertight joint between the connector 300 and a surface mount receiver 101 (shown in FIG. 5) connected to a hydration system (shown in FIG. 1). The outlet connector 300 further comprises an outlet portion 330 having a proximal end 335 and a barbed portion 340 that is configured to connect to a conduit (not shown), thereby creating a fluid passageway from the portal structure, through the outlet connector 300 to the conduit and ultimately to the connectable element connected to the distal end of the conduit.

FIGS. 14 and 15 illustrate a male coupling portion 310 comprising a bottom portion 320, a top portion 322 and a locking means 325 there between. Top portion 322 also includes a sealing means 326, adapted to receive o-ring 360 as shown in FIGS. 15 and 16. In operation, the male potion 310 is inserted into the interior chamber 110 of surface mount receiver 101. The bottom portion 320 passes over the plurality of female connector means 130, 135, 140, 145 and the locking means 325 engages the plurality of female connector means 130, 135, 140, 145 between the top portion 322 and the bottom portion 320. The stop 315 contacts the top surface of a connector 105 of surface mount 101, thereby preventing the male coupling end 310 from extending too far within interior channel 110. The connection between the locking means 325 and the female connector means 130, 135, 140, 145 allows the outlet connector 300 to rotate 360° relative to the surface mount receiver 101.

FIG. 15 shows a front view of outlet connector 300 and FIG. 16 shows a side cut-away section C-C of outlet connector 300. The sealing means 326, when fitted with o-ring 360, creates a watertight seal between the outlet connector 400 and the interior channel 110 of surface mount receiver 101. Outlet connector has interior fluid channels 350, 355 for directing fluid from the interior of a bladder (shown in FIG. 1) to the opening 302 of portal connector or outlet connector 300. The outlet connector 300 facilitates the flow of fluid from the bladder or pouch, through the surface mount receiver to a conduit and ultimately to a connectable element connected to the distal end of a conduit. The outlet connector 300 may also include a bayonet valve or other valve structure to control the flow of fluid through the connector.

FIGS. 17-20 depicts a top perspective, side, front and cut-away view respectively of a typical male insert or outlet connector insert 400. As shown in the top perspective view of FIG. 17, male insert 400 generally comprises a first male coupling end 410 and a second male coupling end 405 with a divider portion 415 separating the two. The first male coupling portion 405 is configured to connect to a conduit and the second male coupling portion 410 is configured to connect to a female receiving portion. A female receiving portion, for example, may typically be found in an outlet connector or a surface mount receiver.

FIG. 18 depicts a side view of male insert 400. The first male coupling portion 405 of male insert 400 comprises an outlet portion 406 having a proximal end 420 with a barbed element 425 configured for connecting to a conduit. In operation a conduit is inserted over barbed element 425 between proximal portion 420 of outlet portion 406 until the conduit contacts divider portion 415. The connection between the conduit and the barbed element 425 is typically a friction fit, thereby effectuating a water tight seal between the conduit and outlet 406 of male insert 400.

The second male coupling portion 410 comprises a top end 432, a bottom end 435 and a coupling means 430 there between. Top end 432 also includes a seal member 436. In a typical operation, the second male coupling potion 410 is inserted into the opening 205 of the outlet connector 200 shown in FIG. 9. The bottom end 435 passes through the opening 205 and over a plurality of female connector means (not shown) and the coupling means 430 engages the plurality of female connector means between the top end 432 and the bottom end 435. The divider portion 415 contacts a surface of the outlet connector 200, thereby preventing the male coupling end 410 from extending too far within channel 240. The connection between the coupling means 430 and the female connector means (not shown) allows the male insert 400 to rotate 360° relative to the opening 205 of the outlet connector 200. The seal member 436 creates a watertight seal between the male insert 400 and the interior channel 240 of outlet connector 200.

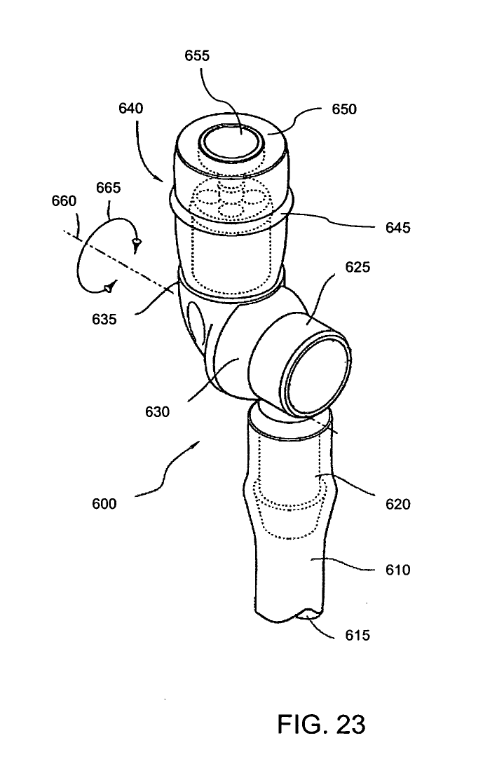

FIGS. 21 and 22 depict the complete articulating port 505 from a top perspective view and a cut-away view. The front perspective view of FIG. 21 illustrates an articulating port 505 comprising an outlet connector 500 and a surface mount receiver 510. The cut-away view of the port structure 505 of FIG. 22 illustrates one embodiment of a connection between the outlet connector 500 and the surface mount receiver 510. A first circular, ring-like groove 508 of outlet connector 500 has an o-ring 515 disposed therein. When the outlet connector 500 is inserted into the surface mount receiver 510, the o-ring 515 forms a watertight seal with the internal channel of surface mount receiver 510. A second circular, ring-like groove 512 of outlet connector 500 is adapted to connect to a plurality of female connectors 520, 525 to connect outlet connector 500 to surface mount receiver 510, while allowing 360° rotational movement and maintaining the watertight seal. Ridges 530, 535, 540 are also shown for maintaining a fluid pathway during a suction action by contacting the interior wall of the bladder so as to keep the interior wall from blocking the fluid flow.

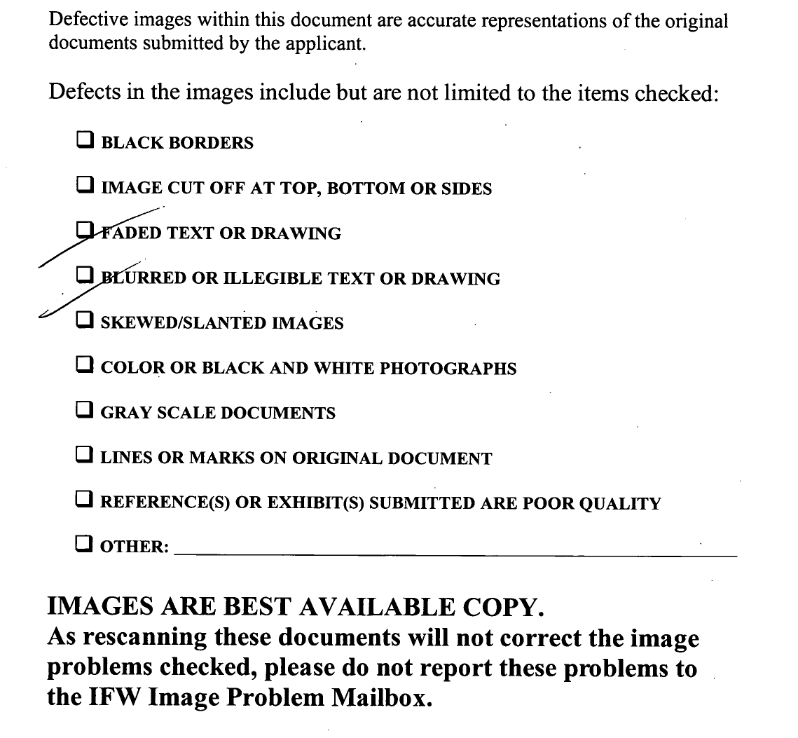

FIG. 23 illustrates one embodiment of the mouthpiece 600 connected to the distal end 610 of conduit 615. Mouthpiece 600 is further described in a commonly owned patent application entitled “Articulating Bite Valve” identified as attorney docket number 45824-01120, which is incorporated by reference for all purposes. In general, the mouthpiece 600 includes a fluid discharge element 640 that controls the flow of fluid from the tube 615 to the user. In the illustrated embodiment, the fluid discharge element 640 is a bite valve comprising an outer sleeve 645 covering a valve post 655 with a channel for communicating fluid through the discharge element to the user's mouth. To prevent the flow of fluid, the closed end 650 of the outer sleeve 645 fits snugly around the end of the valve post 655.

In operation, when a user bites, squeezes or otherwise causes the sleeve 645 to deform, the portion of the sleeve 645 covering the valve post end 655 collapses slightly into a slightly oblong shape. Accordingly, the end closed 650 of the outer sleeve 645 is pulled away from the valve post end 655, allowing fluid to be released from a location interior to outer sleeve 645 to the user's mouth. Other types of fluid discharge elements, such as a nipple or clamp, or a push/pull type valve that is commonly used in cycling water bottles, can be substituted for the illustrated bite valve. Accordingly, the illustrated embodiment is not intended to limit the present system to the illustrated bite valve structure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hydration system for delivering fluid to a user, said hydration system comprising:
a pouch defining a volume, said pouch being formed to contain said fluid, and said pouch having at least one side wall with an opening formed through said side wall for communicating fluid into and out of said volume;
a surface mount receiver connected to said side wall at said opening, said surface mount receiver having a proximal end and a distal end;
an outlet connector through which fluid can pass, said outlet connector having a first end and a second end, said first end being rotatably connected to said proximal end of said surface mount receiver, said connection between said first end and said proximal end having a sealing means for forming a watertight connection, said outlet connector configured to rotate relative to said surface mount receiver at the point where said first end of said outlet connector contacts said proximal end of said surface mount receiver.

2. The hydration system of claim 1, further comprising a first quick connect apparatus having an inlet portion and a female coupling element, said inlet portion coupled to said second end of said outlet connector, said connection between said inlet portion and said second end having a sealing means for forming a watertight connection, said female coupling element sized and adapted to receive and connect to a male coupling element.

3. The hydration system of claim 2, wherein said first quick connect apparatus is configured to rotate at the connection between said male coupling and said female coupling relative to an axis of rotation, said axis of rotation extending through the approximate centers of said male coupling and said female coupling.

4. The hydration system of claim 3, wherein said first quick connect apparatus further comprises a button and an internal valve, said button configured to disconnect said male coupling element from said female coupling element, said internal valve configured to prevent the flow of fluid through said first quick connect apparatus when said male coupling element is disconnected from said female coupling element.

5. The hydration system of claim 1, further comprising a first quick connect apparatus having an inlet portion and a female coupling element, said inlet portion coupled to said second end of said outlet connector, said connection between said inlet portion and said second end having a sealing means for forming a watertight connection, said female coupling element sized and adapted to receive and connect to a male coupling element.

6. The hydration system of claim 5, further comprising a male insert adapter having a male coupling element and a barbed outlet, said male coupling removably connected to said female coupling of said first quick connect apparatus, said connection between said female coupling and said male coupling having a sealing means for forming a watertight connection, said barbed outlet sized and configured for connecting said male insert adapter to a conduit.

7. The hydration system of claim 6, further comprising a conduit having a proximal end and a distal end, said proximal end removably connected to said barbed outlet of said male insert adapter, said distal end sized and configured for connecting said conduit to a connectable element.

8. The hydration system of claim 7, wherein said connectable element comprises a mouthpiece for extracting fluid from said pouch.

9. The hydration system of claim 8, wherein said connectable element comprises a mouthpiece structure for extracting fluid from said pouch, said mouthpiece structure comprising:
a valve head,
a valve body rotatably connected to said valve head, said valve body having a means for connecting said mouthpiece structure to said distal end of said conduit, said valve head and said valve body configured to rotate relative to each other between an open position and a closed position, said open position for facilitating fluid flow to said valve head, said closed position for inhibiting fluid flow to said valve head,
a channel for communicating fluid through said mouthpiece structure between said valve head and said valve body, and
a discharge element operatively coupled to said valve head, said discharge element operable between a first open, position for the transmission of fluid from said mouthpiece to the user and a second closed position to inhibit the transmission of fluid from said valve head.

10. The hydration system of claim 7, wherein said connectable element comprises a second quick connect apparatus having a second inlet portion and a second female coupling element, said second inlet portion removably coupled to said distal end of said conduit, said second female coupling element sized and adapted for receiving and connecting a second male coupling element.

11. The hydration system of claim 10, further comprising a bite valve mouthpiece having a second male coupling element, said second male coupling element rotatably coupled to said second female coupling element, said bite valve mouthpiece being shaped and sized for positioning substantially in and operated by the mouth of the user.

12. The hydration system of claim 1, wherein said surface mount receiver further comprises a plurality of ridges disposed on a bottom surface of said portal structure, wherein said ridges contact an inner surface of said pouch and form a plurality of fluid passageways there between when said surface mount receiver is urged toward said inner surface.

13. A hydration system for delivering fluid to a user, said hydration system comprising:
a pouch defining a volume, said pouch being formed to contain said fluid, and said pouch having at least one side wall with an opening formed through said side wall for communicating fluid into and out of said volume;
a surface mount receiver connected to said side wall at said opening, said surface mount receiver having a proximal end and a distal end;
an outlet connector through which fluid can pass, said outlet connector having a first end and a second end, said first end being rotatably connected to said proximal end of said surface mount receiver, said connection between said first end and said proximal end having a sealing means for forming a watertight connection, said outlet connector configured to rotate relative to said surface mount receiver at the point where said first end of said outlet connector contacts said proximal end of said surface mount receiver;
a first quick connect apparatus having a inlet portion and a female coupling element, said inlet portion coupled to said second end of said outlet connector, said connection between said inlet portion and said second end having a sealing means for forming a watertight connection, said female coupling element sized and configured for receiving and connecting to a male coupling element;
a male insert adapter having a male coupling element and a barbed outlet, said male coupling element removably connected to said female coupling of said quick connect, said connection between said female coupling and said male coupling element having a sealing means for forming a watertight connection, said barbed inlet sized and configured for connecting to a conduit;
a conduit for communicating liquid to the user, said conduit having a proximal end connected to said second end of said outlet connector and a distal end; and
a connectable element connected to said distal end of said conduit, said connectable element having a channel for communicating liquid through said connectable element.

14. The hydration system of claim 13, wherein said surface mount receiver further compnses:
a plate; and
a surface mount attached to said plate, said surface mount configured for receiving said first end of said outlet connector, said surface mount having an internal conduit for passing fluid from said pouch to said outlet connector.

15. The hydration system of claim 14, wherein said outlet connector has a first coupling means located on said first end, and wherein said surface mount receiver has a second coupling means interior to said surface mount receiver, said first and second coupling means configured to create a watertight seal when said outlet connector is attached to said surface mount receiver.

16. An articulating port structure attachable to the bladder of a hydration system, said articulating port structure comprising:
a surface mount receiver structure configured to connect to a side wall of said bladder at an opening, said surface mount receiver having a proximal end and a distal end; and
an outlet connector through which fluid can pass, said outlet connector having a first end and a second end, said first end being rotatably connected to said proximal end of said surface mount receiver structure, said connection between said first end and said proximal end having a sealing means for forming a watertight connection, said outlet connector configured to rotate relative to said surface mount receiver structure at the point where said first end of said outlet connector contacts said proximal end of said surface mount receiver structure.

17. The port structure of claim 16, further comprising a first quick connect apparatus having an inlet portion and a female coupling element, said inlet portion coupled to said second end of said outlet connector, said female coupling element sized and adapted to receive and connect to a male coupling element.

18. The port structure of claim 17, further comprising:
a male insert adapter having a male coupling element and a barbed outlet, said male coupling element removably connected to said female coupling of said quick connect, said barbed outlet sized and configured for connecting to a conduit; and
a conduit for communicating liquid to the user, said conduit having a proximal end connected to said barbed outlet and a distal end.

19. The port structure of claim 18, further comprising a connectable element coupled to said distal end of said conduit, said connectable element having a channel for communicating liquid through said connectable element.

20. The port structure of claim 19, wherein said connectable element comprises a second quick connect apparatus having a second inlet portion and a second female coupling element, said second inlet portion removably coupled to said distal end of said conduit, said second female coupling element sized and adapted for receiving and connecting a second male coupling element.

21. The port structure of claim 20, further comprising a bite valve mouthpiece having a second male coupling element, said second male coupling element rotatably coupled to said second female coupling element, said bite valve mouthpiece operable between a first open position for transmitting liquid from said conduit to said user and a second closed position for inhibiting the transmission of fluid from said connectable element, said bite valve mouthpiece being shaped and sized for positioning substantially in and operated by the mouth of the user.
